(19) United States
(12) Patent Application Publication
(10) Pub. No.: US 2009/0211974 A1
(43) Pub. Date: Aug. 27, 2009

(54) WATER CLARIFYING APPARATUS AND IMPLEMENTING METHOD

(75) Inventors: Veronique Bonnelye, Conflans Sainte Honorine (FR); Jacques Moles, Rueil Malmaison (FR)

Correspondence Address: CONNOLLY BOVE LODGE & HUTZ LLP, 1875 EYE STREET, N.W., SUITE 1100, WASHINGTON, DC, 20006, US

(73) Assignee: DEGREMONT, Rueil-Malmaison (FR)

(21) Appl. No.: 12/066,184

(22) PCT Filed: Sep. 6, 2006
(86) PCT No.: PCT/FR2006/002052

§ 371 Date: Aug. 29, 2008

(30) Foreign Application Priority Data
Sep. 9, 2005 (FR) 0509236

(51) Int. Cl. C02F 1/52; B01D 21/00; C02F 1/24; B01D 61/16

(52) U.S. Cl. 210/636; 210/311; 210/639; 210/650

(57) ABSTRACT

The invention concerns a water clarifying device comprising a flotation zone (c), a membrane-based filtering zone (e) and extracting means (d), the flotation zone (c) and the membrane-based filtering zone (e) having a common partition wall (P), the common partition wall (P) including in its lower part an opening (o) directly allowing through flotated water towards the filtering zone (e), thereby feeding the membranes with flotated water from down upwards both in filtering phase and in backwashing phase.

The present invention relates to a water clarification device comprising a flotation zone, a membrane filtration zone and extraction means, the flotation zone and the membrane filtration zone having a common partition.

Water treated before release into the natural environment, intended for consumption or to be used in installations, may contain suspended matter (particles, algae, bacteria, etc.) and dissolved matter (organic matter, micropollutants, etc.) and have very variable quality characteristics, typically a turbidity of 0.1 to 200 NTU, and a temperature of 0.5° C. to 50° C. These waters require a clarification treatment.

There are several types of clarification, especially dissolved air flotation, membrane filtration and settling/membrane filtration or flotation/membrane filtration combinations.

Dissolved air flotation, usually called DAF, is one of the clarification treatments used for clarifying water with a view to producing drinking water, process water and in the wastewater pollution control systems. It generally comprises a combination of various steps:
a coagulation in order to neutralize the surface charges of the colloids, and adsorption of dissolved matter;
a flocculation enabling particle agglomeration;
an injection of pressurized water enabling microbubbles generated by the pressure release to be brought into contact with flocculated water;
a separation allowing the separation of the floc and the clarified water;
a collection of the clarified water; and
a collection of the floated “sludge”.

Flotation technology has been the subject of numerous improvements, for example turbulent flotation (U.S. Pat. No. 5,516,433) which uses, at the bottom of the flotation zone, elements for controlling and distributing the flow that make it possible to obtain, upstream of these elements, a nonuniform flow, this phenomenon generating an internal circulation that is the subject of the patent cited above.

This dissolved air flotation technology, although optimized, does not have a yield of 100% for removal of particles and coagulated matter and requires, in all cases, a filtration for separating the residual floc not retained in the flotation system from the clarified water.

Clarification by membrane filtration uses filtration, ultrafiltration and microfiltration membranes which are characterized by a cutoff threshold that makes it possible to delimit a physical barrier, acting as an actual screen. Depending on their geometry and threshold cutoff characteristics, the ultrafiltration (UF) and microfiltration (MF) membranes are particularly well suited for clarifying water that contains particles such as suspended matter, microorganisms, etc. The limits for the application of membranes in water clarification are of two types:
poor elimination of dissolved compounds, organic matter and molecules whose size is smaller than the membrane cutoff threshold; and
limited hydraulic capacity linked to the clogging of the membranes by the material retained during the filtration (known as filter cake), in particular during the treatment of water containing high concentrations of suspended matter or of organic matter.

In the same way as filtration over granular media, ultrafiltration and microfiltration membrane filtration sees its performance increased when it is preceded by a pretreatment step.

JP 2005 046684 describes a membrane bioreactor for treating liquid effluent containing soluble organic matter. Aeration means are provided in the lower part of the treatment zone to create large air and/or oxygen bubbles in order to oxygenate the bacteria used. These bubbles will spread throughout the bioreactor and cause stirring, which does not allow a flotation zone to be created.

The combination of a coagulation/settling and membrane filtration treatment has been known for several years and has already been the subject of many industrial implementations (San Antonio, Tex.; Capot River, Martinique). This combination has demonstrated its advantage in terms of improvement of the removal of dissolved matter, which may be subjected to a coagulation, and improvement of the membrane filtration performance.

The coupling of the two clarification steps, namely dissolved air flotation and membrane filtration, is also well known, both on the scale of pilot studies and industrial implementations (San Joakim). The systems thus comprise a dissolved air flotation step, followed by a membrane filtration step. Each process is managed independently and there is no real optimization of the possibilities arising from the combination of these two technologies.

There have been several attempts to combine the two processes by submerging the membranes directly in the flotation zone. In the existing devices, the membranes are located underneath the cake of flotation water derived from the flotation. Knowing the hydraulics and the behavior of a dissolved air flotation, a person skilled in the art immediately identifies the limits of this type of arrangement. Since the separation of the microbubbles from the clarified water is not finished at the inlet of the membranes due to the geometry of the structure, clogging is generated by accumulation of microbubbles in the filtration modules. The only way of limiting this phenomenon is therefore to increase the head of water above the membrane stage, which leads to high structure heights.

Furthermore, the positioning of the membranes in the flotation zone and under the cake of floated sludge renders any injection of air impossible at the risk of breaking this cake and putting the agglomerated matter in this cake back into suspension, increasing the concentration of suspended matter in the vicinity of the membranes, to the detriment of the performance of the filtration membranes.

Lastly, the control of this dissolved air flotation/membrane filtration assembly is difficult, since the operations for draining the structure can only be carried out after removal of the surface sludge.

It is furthermore difficult to carry out a turbulent type flotation which requires a flow control and distribution system, between the flotation and the membranes.

In addition, the membranes represent a large part of the cost of an installation, it is therefore expensive to increase the number or the surface area of these membranes, in order to face up to a drop in performance of these membranes due to the flotation.

In view of these various drawbacks and difficulties, the inventors have developed, which is the subject of the invention, a device and a process for increasing the treatment rates of the water and to facilitate the maintenance of the plant without significant repercussion on the running costs.

According to the invention, a water clarification device of the type defined previously is characterized in that the common partition comprises an opening in its lower part allowing a direct flow of the flotation water toward the filtration zone, which results in the membranes being fed with flotation water from the bottom up both in the filtration phase and in the backwashing phase. Ideally, the flow regime in the vicinity of this opening will be laminar.

Preferably, the flotation zone may comprise means that make it possible to establish a turbulent flotation.

More preferably, the extraction means may comprise two overflows located above the partition and comprising means of communicating with the flotation zone and the filtration zone making it capable of receiving fluid originating from either the flotation zone or from the filtration zone.

More preferably still, the filtration zone may be compartmentalized. In this case, each compartment may be isolated from the other zones by a wide-opening valve.

Advantageously, the filtration zone may also be completely open at the top.

According to one preferred embodiment of the device according to the invention, baffles or fins may be provided in the vicinity of the opening in the partition in order to create a hydraulic laminar regime.

The present invention also relates to a water clarification process comprising a flotation step, a membrane filtration step, and a step of extracting sludge derived from the flotation step, characterized in that the flow of flotation water toward the filtration zone is direct so that the feed of the membranes with flotation water is carried out from the bottom up both in the filtration phase and in the backwashing phase.

Preferably, the process may comprise a step of cleaning the device used for extracting sludge using flotation water.

More preferably, the process may comprise control of the recovery levels in the extraction collector.

Advantageously, the process may comprise a step of injecting additional reagents between the flotation step and the filtration step.

Other features and advantages of the invention will be given in the following examples, with reference to the drawings in which:

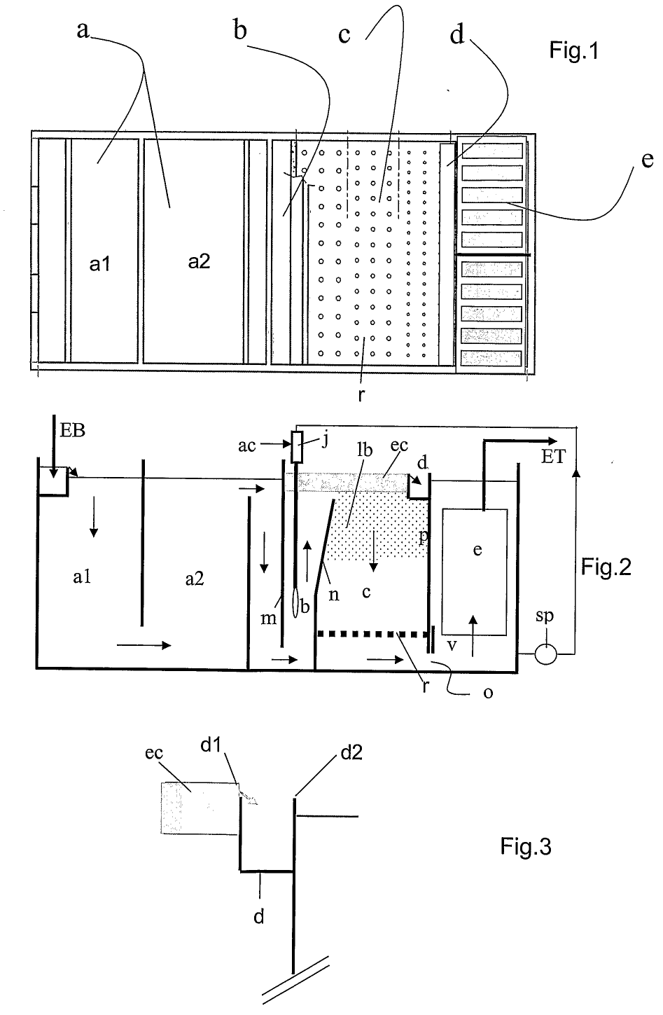

FIG. 1 is a schematic top view of a device according to the invention, the flow of material to be treated moving from left to right;

FIG. 2 is a schematic longitudinal cross section of a device similar to that from FIG. 1 in a phase of operating with extraction of the sludge derived from the flotation zone;

FIG. 3 is a detail of the extraction of the sludge derived from the flotation zone that can be seen in FIG. 2;

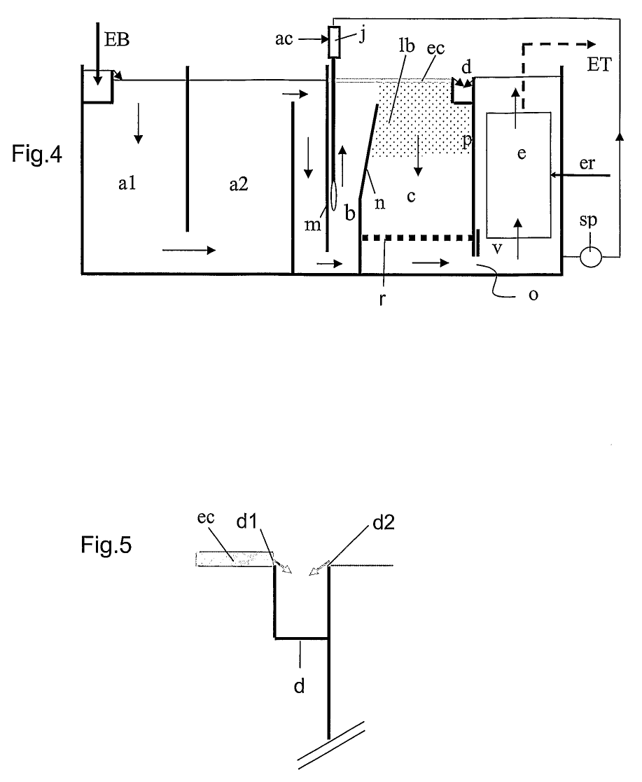

FIG. 4 is a view similar to that from FIG. 2 in the case of the use of flotation water for cleaning the sludge extraction means; and

FIG. 5 is a detail of the use of flotation water that can be seen in FIG. 4.

With reference to FIGS. 1 and 2, it is possible to see that a device D according to the invention comprises:
a double flocculation zone a1/a2 into which raw water EB to be treated penetrates via an overflow;
a pressure release and mixing zone b;
a flotation zone c equipped with an element for distributing the flow r;
a common collection zone for the water for deconcentration, membrane backwashing and floated sludge d; and
a compartmentalized zone where the filtration membranes are positioned e and from where the treated water ET is then extracted.

The flocculation time in the zone a is between 5 and 25 minutes, typically between 5 and 15 minutes. The flotation time in the zone c is between 5 and 10 min. The residence time in the zone e is between 2 and 5 min.

As can be seen, the device uses the two clarification technologies which are turbulent flotation such as described in U.S. Pat. No. 5,516,433, and submerged membrane filtration, with microfiltration, ultrafiltration, nanofiltration or hyperfiltration type membranes, using membrane geometries of hollow fiber, spiral or planar type, in such a way that the equipment of each of the two technologies are shared.

This type of arrangement has never been carried out in the current state of knowledge with a turbulent flotation, and this, even more than the circulation inside the flotation unit, is not compatible with the circulation which would be required for correct operation of the membranes.

Specifically, the turbulent flotation comprises elements for distributing the flow r, positioned at the bottom of the flotation zone c, that make it possible to ensure a homogeneous hydraulic distribution in the latter. The flotation water is collected under these flow distribution elements. In the present invention, use is made of this flotation water (downstream of the flotation zone c) to achieve optimum hydraulics for feeding the membrane modules in a laminar regime in order not to destroy the residual flocs, and that makes it possible to combine an ascending feed and a stream of bubbles that is also ascending.

The letter “j” denotes a device that makes it possible to create a bed of microbubbles lb in the upper part of the flotation zone c by injection of compressed air ac into the bottom of the mixing zone b. The device j comprises a mixing pot or body extended from its inner part by a vertical injection tube. The lower end of the injection tube is equipped with pressure-release nozzles in order to obtain very fine bubbles, especially bubbles of microscopic size. These microbubbles will agglomerate the impurities present in the water to be treated and form a layer of scum ec or floc.

Before being injected, the compressed air ac is mixed with pumped water, at the base of the filtration zone e via a pumping system sp.

The injection of the microbubbles is carried out in a channel formed by the walls m and n which separate the pressure release and mixing zone b from the flocculation zone a located upstream and from the flotation zone c located downstream. The wall m comprises an opening at the base and the wall n comprises an opening in its upper part, level with the layer of scum ec, so as to allow circulation of the water to be treated.

The bed of microbubbles lb is located underneath the layer of scum ec. The clarification is carried out in the bed of microbubbles lb.

Taking into account the very low speeds involved in the zone which connects the flotation zone and the membrane modules, the flocs resulting from the flotation zone do not undergo any transfer with a high dissipation of energy, which transfer could be generated, for example, in a duct or by a pump. These flocs therefore retain their cohesion and their filterability despite their fragility. This is expressed by an obvious gain in terms of flow that can pass through the membranes.

The filtration membranes, generally composed of modules juxtaposed horizontally and/or vertically, form an assembly which is inserted into the filtration zone e. The filtration is carried out either by means of a pump, not shown, creating an underpressure and sucking up the permeate, or by means of a siphon or any other component that makes it possible to maintain a pressure difference between the concentrate side of the membrane submerged in the flotation water, and the permeate side of the membrane, this pressure difference providing the driving force that enables the water to pass through the membrane.

As described below, the invention implements adjustments in order to adapt the flotation and membrane filtration process.

The flotation water is removed from the structure through the permeate collector of the submerged membranes.

The outlet of the flotation sludge, collected at the surface, and the outlets for the deconcentration or backwashing waters are made in the upper part of the structure, in a common collection zone d, which facilitates the construction and simplifies the operation. Furthermore, the feed of deconcentration and/or backwashing water makes it possible to assist the transport of the floated sludge, the concentration and physical state of which sometimes disturb the flow, hence the need to provide dilution water at this point.

An outlet is positioned in such a way that it predominantly relates to the membrane filtration zone e. An outlet from the zone e where the ultrafiltration and microfiltration membranes are positioned is necessary in order to allow the backwashing operations assisted by draining and chemical washing of the membranes.

In this configuration, the maintenance operations may be carried out independently of the operation of the flotation zone c: the membrane filtration zone e being divided into several compartments, one part of the membrane surface installed may be affected by maintenance operations without the operation of the rest of the unit being affected.

A second objective of the invention is to couple the control systems for the turbulent flotation and membrane filtration processes.

The flow rate of permeate extracted from the submerged membranes must be consistent with the flow rate from the flotation zone c. For this, the permeate flow rate is controlled as a function of the water level at the inlet of the device. In particular, in the filtration phase, a slight underflow of permeate will be expressed by an overflow of water, level with the collection of floated sludge, helping them to be discharged.

During a backwashing of a membrane block, water is injected tangentially to the membranes in order to detach impurities from the membranes. The feed flow rate of the apparatus is kept constant. The fraction of flotation water which does not pass through the membranes and which will be recovered in the collection zone d assists the backwashing water in the dilution of the compartment of the membranes, this being from the bottom up. The dirty backwashing water is then discharged via the upper part of the structure. The level of the outlet overflow may be fixed or equipped with a control system, that can be adapted as a function of the desired level of recovery.

During a drained backwashing, the block of membranes is isolated from the flotation unit c by a wide-opening wall valve v, allowing the selective draining of the membrane block. The backwashing thus carried out allows a better dilution of the membranes, and a better removal of the filter cake.

During a hydraulic removal of the sludge, the membrane permeation flow rate is limited by the control system, enabling an increase in the water level in the device, and therefore an extraction of the sludge hydraulically.

During a chemical washing, the membrane block is isolated from the flotation unit c by the wall valve v in the course of the chemical washing step.

During a complete draining of the structure, the membrane block and the flotation unit c are drained simultaneously.

Due to the architecture of the device, the flow in the filtration zone e remains constantly directed upward. During a backwashing, the particles resulting from the dirtiest parts of the membranes, which are found at the top due to the almost zero speed of the flotation waters near the surface, will therefore not be redeposited on the cleaner parts.

The floc formed in the turbulent flotation stage has two characteristics: on the one hand, it is fragile, considering the very nature of the water and the obligation to avoid any overdosing of flocculent which would be damaging to the membrane filtration downstream; on the other hand, having “matured” in a zone having a high concentration of particles (the bubble bed), it is easier to filter and the cake formed at the surface of the membranes is more permeable to water.

The floc filtered on the filtration membrane has, at this stage of the process, a structure protected from any modification linked to pumping or to an outfall or any other hydraulic collection and transfer means. The flow time of the floc between the separation zone of the flotation unit and the membrane filtration is between 10 and 60 seconds, typically 30 seconds.

The clogging ability of this residual, physically preserved, floc is reduced compared to a floc that has undergone a structural modification, generally a deflocculation during the passage in the transfer components and structures. This floc with low clogging ability is retained by the filtration membrane due to the cutoff threshold of the latter. This floc having low clogging ability then forms a filter cake, corresponding to the accumulation of particles at the surface of the filtration membrane, of increased porosity, characterized by a lower specific resistance to the passage of a fluid such as water, and therefore that allows the application of higher filtration flows, generally of +5 to +25%, typically of +10 to +20%.

The arrangement of the flotation zone c and the membrane filtration zone e allows an optimization of the filtration process through the possibility of providing an intermediate conditioning of the water by means of coagulant, PAC, polymer, acid or base.

In the case of a simple coagulation, the coagulant treatment level may be optimized from the jar test to promote the floc floatability characteristics. The flotation is then carried out at its optimum performance. Subsequently, the addition of a new dose of coagulant between the flotation zone c and the filtration zone makes it possible to modify the characteristics of the flocs, making them more suitable for membrane filtration (lower resistance of the cake to the flow of water, easier detachment of the cake during backwashing). Often without impact on the quality of the permeate obtained, this second injection of coagulant makes it possible to better control the membrane filtration, and to increase the filtration flow rates while decreasing the frequency of chemical washing operations.

In the case of a coagulation at two pH values, the desired advantage is a better removal of the organic matter. It is well known to a person skilled in the art that the coagulation of humic and fulvic acids, main components of dissolved natural organic matter, is more effective in an acid medium. The main pH limit is linked to the increase of the solubility of the Fe and Al ions responsible for the coagulation. The invention allows coagulation to be carried out at two pH values, acid pH in the flotation zone enabling an optimum removal of the organic matter, and immediate pH correction upstream of the filtration membranes in order to precipitate the residual coagulant, in order that it be retained by the filtration membrane.

In the case of a final pH correction in order to return the water to calcium/carbon equilibrium, after the filtration step, this final correction may be carried out by addition of sodium hydroxide (but this solution leads to a significant increase in the concentration of sodium ions in the treated water, and it is an expensive reagent) or by injection of limewater, the latter case involves the construction of a lime saturator that is expensive and difficult to use. The partial pH correction between the flotation zone c and the membrane by addition of limewater makes it possible to envision a metering of limewater as the membranes are capable of retaining the uncalcined parts of the lime, whereas the calcium ion will increase the filterability of the cake.

Pilot trials have been carried out in order to demonstrate the efficiency of this novel water clarification process, coupling a turbulent dissolved air flotation and a submerged membrane filtration.

### EXAMPLE 1

### Clarification of a Surface Water

The quality of the water feeding the pilot unit is described in the following table. The water came from a reservoir, characterized by a low turbidity, by the presence of organic matter (TOC-UV) at high concentrations and by algal blooms, the latter possibly reaching concentrations of 50 000 algae/ml.

TABLE 1-1

| | | Flotation | Ultrafiltered |
|---|---|---|---|
| Parameters | Raw water | water | water |
| Temperature | 1-10° C. | 1-10° C. | 1-10° C. |
| Turbidity | 0.5-2 NTU | 0.4-2.8 NTU | <0.1 NTU |
| Total | 5-8 mg/l | 2.6-4.3 mg/l | 2.3-4.0 mg/l |
| organic | | | |
| carbon | | | |
| UV | 8-12/m | 6-8/m | 4.5-5/m |
| absorbance | | | |
| Algae | 2 940-52 800 algae/ml | 523-2210 algae/ml | 0 algae/ml |

The hydraulic performances are given in detail in the following table:

TABLE 1-2

| | | | Performance of |
|---|---|---|---|
| | | | membrane |
| | | Single | filtration |
| | | membrane | assisted by |
| Type of | Flotation | filtration | intermediate |
| operation | performance* | performance** | conditioning** |
| Direct | — | 25-30 l/h/m² | — |
| filtration | | | |
| of surface | | | |
| water | | | |
| Turbulent | 20-30 m/h | 35-45 l/h/m² | 55-60 l/h/m² |
| flotation | | | |
| then | | | |
| membrane | | | |
| Invention: | 25-45 m/h | 40-60 l/h/m² | 60-70 l/h/m² |
| turbulent | | | |
| flotation + | | | |
| membrane | | | |
| coupling | | | |

*Flotation rate in m³/m²/h;
**Filtration flow in l/h/m² at the filtration temperature.

### EXAMPLE 2

Pretreatment of Seawater in Open Intake

The quality of the water feeding the pilot unit is described in the following table:

TABLE 2-1

| | | Flotation | Ultrafiltered |
|---|---|---|---|
| Parameters | Raw water | water | water |
| Temperature | 30-36° C. | 32-37° C. | 32-38° C. |
| Turbidity | 0.2-10.5 NTU | 0.5-2.2 NTU | <0.1 NTU |
| Clogging | 10-28 | — | 1.4-3.6 |
| index (SDI) | | | |
| UV | 0.8-1.2/m | 0.6-0.9/m | 0.5-0.8/m |
| absorbance | | | |
| Conductivity | 55-56 mS/cm | 55-56 mS/cm | 55-56 mS/cm |

The hydraulic performances are given in detail in the following table:

TABLE 2-2

| Type of | Flotation | Membrane filtration |
|---|---|---|
| operation | performance* | performance** |
| Direct | — | 20-30 l/h/m² |
| filtration of | | |
| surface water | | |
| Turbulent | 25-35 m/h | 45-55 l/h/m² |
| flotation then | | |
| membrane | | |
| Invention: | 30-45 m/h | 50-65 l/h/m² |
| turbulent | | |
| flotation + | | |
| membrane | | |
| coupling | | |

*Flotation rate in m3/m2/h;
**Filtration flow in l/h/m2 at the filtration temperature.

### EXAMPLE 3

The quality of the water feeding the pilot unit is described in the following table: this study relates to the application of the innovation in tertiary treatment of municipal wastewater.

TABLE 3-1

| | | Flotation | Ultrafiltered |
|---|---|---|---|
| Parameters | Raw water | water | water |
| BOD5 | 22 mg/l | 16 mg/l | 11 mg/l |
| COD | 54 mh/l | 39 mg/l | 30 mg/l |
| Suspended | 18 mg/l | 9 mg/l | 0 mg/l |
| matter | | | |
| Transmittance | 55% | 70% | 80% |
| P-PO4 | 3 mg/l | 1 mg/l | <0.1 mg/l |

The hydraulic performances are given in detail in the following table.

TABLE 3-2

| Type of | Flotation | Membrane filtration |
|---|---|---|
| operation | performance* | performance** |
| Direct | — | 15-25 l/h/m² |
| filtration of | | |
| surface water | | |
| Turbulent | 20-25 m/h | 25-40 l/h/m² |
| flotation then | | |
| membrane | | |
| Invention: | 25-45 m/h | 40-65 l/h/m² |
| turbulent | | |
| flotation + | | |
| membrane | | |
| coupling | | |

*Flotation rate in m3/m2/h;
**Filtration flow in l/h/m2 at the filtration temperature.

In conclusion, the device according to the invention therefore makes it possible to obtain:
a reduction in the footprint and the cost of installations by sharing structures and equipment;
a common management of the various steps of the process, leading to a simplified control; and
an improvement in the hydraulic performances of the flotation and membrane filtration steps: an improvement in the whole of the clarification process linked to the specific hydraulic conditions generated by this combination, allowing a reduction in the membrane surface area required.

In the three cases detailed above, the pilot studies have made it possible to demonstrate the compactness of the system compared to a direct membrane filtration and compared to the simple juxtaposition of a dissolved air flotation structure and a membrane filtration. This compactness is linked to the use of equipment common to the two processes, and to the improvement in the performance of each of the treatment steps compared to systems that are simply juxtaposed.

1. A water clarification device comprising a flotation zone (c), a membrane filtration zone (e) and extraction means (d), the flotation zone (c) and the membrane filtration zone (e) having a common partition (P), wherein the common partition (P) comprises an opening (o) in its lower part allowing a direct flow of the flotation water toward the filtration zone (e), which results in the membranes being fed with flotation water from the bottom up both in the filtration phase and in the backwashing phase.

2. The device as claimed in claim 1, wherein the flotation zone (c) comprises means that make it possible to establish turbulent flotation.

3. The water clarification device as claimed in claim 1, wherein the extraction means (d) comprise two overflows (d1, d2) located above the partition and comprising means of communicating with the flotation zone (c) and the filtration zone (e) making it capable of receiving fluid originating from either the flotation zone (c) or from the filtration zone (e).

4. The water clarification device as claimed in claim 1, wherein the filtration zone (e) is compartmentalized.

5. The water clarification device as claimed in claim 4, wherein each compartment can be isolated from the other zones, by a wide-opening valve (v).

6. The water clarification device as claimed in claim 1, wherein the filtration zone (e) is completely open at the top.

7. The water clarification device as claimed in claim 1 wherein baffles or fins are provided in the vicinity of the opening in the partition (P) in order to create a hydraulic laminar regime.

8. A water clarification process comprising a flotation step, a membrane filtration step, and a step of extracting sludge derived from the flotation step, wherein the flow of flotation water toward the filtration zone is such that the feed of the membranes with flotation water is carried out from the bottom up both in the filtration phase and in the backwashing phase.

9. The water clarification process as claimed in claim 8, wherein it comprises a step of cleaning the device used for extracting sludge using flotation water, coming from the filtration zone during the backwashing of the membranes.

10. The water clarification process as claimed in claim 8 wherein it comprises control of the recovery levels by means of a variable sill in the extraction collector.

11. The water clarification process as claimed in claim 8 wherein it comprises a step of injecting additional reagents between the flotation step and the filtration step.

12. The use of the device as claimed in claim 1 for clarifying seawater, brackish water, surface water or treated wastewater, of municipal or industrial origin.

13. An application of the process as claimed in claim 8 for clarifying seawater, brackish water, surface water or treated wastewater, of municipal or industrial origin.
